(19) United States
(12) Patent Application Publication
(10) Pub. No.: US 2002/0121810 A1
(43) Pub. Date: Sep. 5, 2002

(54) Control device for a vehicle occupant protection device

(76) Inventors: Horst Belau, Langquaid (DE); Marten Swart, Obertraubling (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/113,161

(22) Filed: Apr. 1, 2002

Related U.S. Application Data
(63) Continuation of application No. PCT/DE00/03350, filed on Sep. 26, 2000.

(30) Foreign Application Priority Data
Sep. 30, 1999 (DE) 199 47 096.0
Jan. 20, 2000 (DE) 100 02 375.4

(51) Int. Cl. B60L 1/00

(52) U.S. Cl. 307/10.1

(57) ABSTRACT

A vehicle occupant protection device having a firing cap for activating the vehicle occupant protection device is controlled with a control device. An energy source provides a supply voltage for the firing cap. A switching transistor connects the firing cap to the energy source. A controlled path of the switching transistor, the energy source, and the firing cap are connected in series with respect to one another. An actuation or control circuit is connected upstream of a control terminal of the switching transistor and controls the switching transistor in such a way that a resistance of the controlled path in the switched-on state of the transistor is kept constant, a signal which is present at the control terminal at that time is evaluated, an energy which is converted in the switching transistor is determined from the signal at the control terminal and, when a predefined energy limiting value is reached, the switching transistor is switched off.

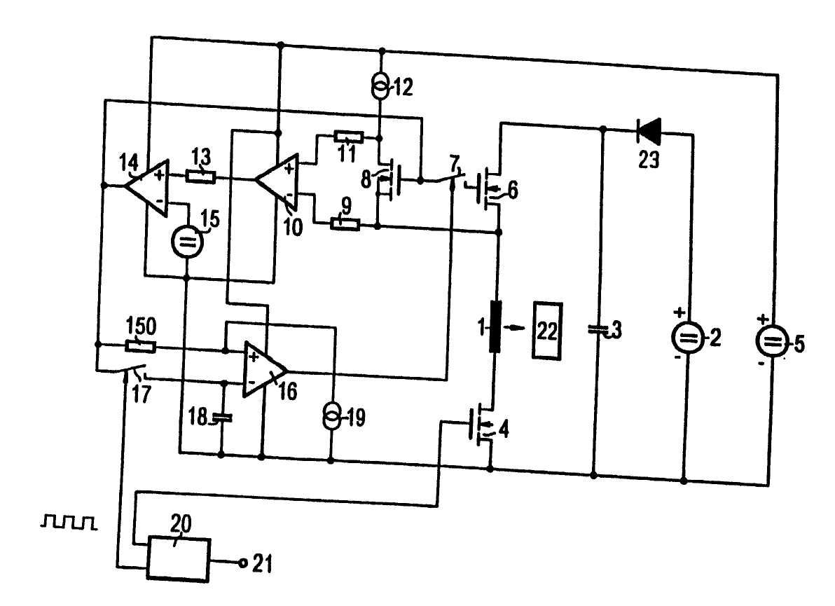

### CROSS-REFERENCE TO RELATED APPLICATION:

This application is a continuation of copending International Application No. PCT/DE00/03350, filed Sep. 26, 2000, which designated the United States.

### BACKGROUND OF THE INVENTION

### FIELD OF THE INVENTION

The invention relates to a control device for a vehicle occupant protection device.

A prior art controller which is described, for example, in U.S. Pat. No. 5,194,755 contains a series circuit composed of a first controllable switching stage, a firing element which is assigned to the vehicle occupant protection device, and a second controllable switching stage. The series circuit is fed from an energy source. If both switching stages are placed in the conductive state, energy from the energy source is fed to the firing element. The firing element which is embodied as a heating resistor is heated up as a result of the flow of current and brings about a release of gas in the associated gas generator. The released gas flows, for example, into an airbag. Other vehicle occupant protection devices, such as seatbelt protection devices or roll-over bars, can also be operated in a similar way.

A plurality of such firing circuits or trigger circuits are often arranged in parallel with one another, in particular the switching stages being integrated on a common circuit carrier as an ASIC (application-specific integrated circuit). All the firing circuits are preferably fed from a common energy source. The energy source can be the vehicle battery or a firing capacitor which releases energy in the event of the vehicle battery being damaged in an accident. The firing capacitor is dimensioned here in such a way that it has sufficient energy to fire all the firing elements. The firing elements of different firing circuits can be fired independently of one another and also at different times.

In order to ensure that a firing element is actually fired, it is necessary to make the switch-on time very much longer than is actually necessary. However, for this reason, the energy source and in particular a firing capacitor which is connected in parallel for buffering the vehicle battery has to be given a much larger configuration than is actually necessary. Moreover, one of the firing elements may short-circuit during firing and as a result a large quantity of energy would flow out of the firing capacitor via the short-circuit. For firing elements which have to be subsequently fired, the firing capacitor would then no longer be able to make available sufficient energy.

### SUMMARY OF THE INVENTION

It is accordingly an object of the invention to provide a controller for a vehicle occupant protection device, which overcomes the above-mentioned disadvantages of the heretofore-known devices and methods of this general type and which ensures that less power loss energy is removed from the energy source.

With the foregoing and other objects in view there is provided, in accordance with the invention, a control device for a vehicle occupant protection device with a firing cap for activating the vehicle occupant protection device, comprising:

an energy source for providing a supply voltage for the firing cap;

a switching transistor for connecting the firing cap to the energy source, the switching transistor having a control terminal and having a controlled path connected in series with the energy source and the firing cap; and

a control circuit connected to the control terminal of the switching transistor and configured to control the switching transistor to:

maintain a resistance of the controlled path constant in a switched-on state of the transistor, evaluate a signal present at the control terminal at that time, determine an energy being converted in the switching transistor from the signal at the control terminal and, when a predefined energy limiting value is reached within a specific time, switch off the switching transistor.

The advantage of the invention is that the firing energy can be metered individually for each individual firing circuit, i.e. for each firing element. In the process, only as much energy is fed to the firing elements as they require for firing. As a result, relatively small energy accumulators can be provided, which require less space and entail lower costs and better efficiency. Therefore, with the same energy source it is possible to supply a larger number of firing elements.

This is achieved in that, by suitably controlling transistors which are used as switching stages in the switched-on state it is possible to keep the resistance of the transistors on the controlled path constant. The flow of current through the transistors causes them to heat up. The semiconductor volume of the transistor acts here as a thermal capacitor of an energy integrator. In the process, increases in the temperature of the silicon caused by the increase in energy result in a corresponding increase in the resistance on the controlled path of the transistor. In order to keep the resistance on the controlled path constant despite the changing temperature, a change in the actuation voltage is necessary. The change in voltage is therefore proportional to the temperature and can thus be used to calculate the energy. After the start of the recording of the energy, the controlled switching off of the switching stage or stages is carried out by means of a corresponding energy calculation.

In particular, with a series circuit which is fed from an energy source and is composed of a firing element and the controlled path of a switching transistor, the control terminal of the switching transistor is controlled by an actuation circuit connected upstream, said control terminal being controlled in such a way that the resistance of the controlled path in the switched-on state of the transistor is kept constant, that the signal which is present at a control terminal is evaluated, the energy which is converted in the switching transistor is determined from the signal at the control terminal and, when a predefined energy limiting value is reached within a specific time, the switching transistor is switched off.

In accordance with an added feature of the invention, a capacitor is connected in parallel with the energy source. The capacitor is, for example, a firing capacitor, and is used to provide the energy for the firing elements in the event of the vehicle battery failing. It is also possible to provide as an energy source for firing just one capacitor whose charge voltage can also be above the voltage of the vehicle's electrical system.

The actuation circuit is preferably connected to a sensor, for example a crash sensor. In the case of specific signals of the sensor, for example in the case of signals corresponding to an impact, the switching transistor is then switched through by the actuation circuit as a function of the sensor signal. When the switching transistor is switched through, it is preferably clocked, as a result of which the energy is fed to the switching transistor in portions. In the process, the energy portions are emitted by means of pulses in such a way that an individual pulse cannot give rise to firing. In this way, very simple metering of the energy quantity is possible and all the firing circuits (with different firing caps) can advantageously be provided from just a single energy accumulator.

In accordance with an additional development of the invention the control circuit has a comparator transistor whose controlled path is fed by a power source, and wherein, in order to determine the resistance on the controlled path of the switching transistor, the resistance on the controlled path of the comparator transistor is determined by determining the voltage over the controlled path of the comparator transistor. In this way, it is possible to determine the resistance of the switching transistor on the controlled path with little expenditure and a high degree of precision and without engaging in the output circuit of the switching transistor.

When a comparator transistor is used, it is also possible to provide that the resistance on the controlled path of the comparator transistor is determined when the switching transistor is switched off, the respective current resistance value is stored when the switching transistor is switched on, the control terminal of the switching transistor is coupled to the control terminal of the comparator transistor when switching on occurs, and subsequently the voltage value at the coupled control terminals of the switching transistor and comparator transistor is regulated with respect to the stored voltage value of the comparator transistor when switching on occurs. In the process, the change in the actuation voltage is evaluated and used for energy calculation. In this way, the energy drain of the switching transistor can be determined with high precision and little expenditure.

Other features which are considered as characteristic for the invention are set forth in the appended claims.

Although the invention is illustrated and described herein as embodied in a control device for a vehicle occupant protection device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing is a schematic circuit diagram of a controller according to the invention.

### DESCRIPTION OF THE PREFERRED EMBODIMENTS

Referring now to the figure of the drawing in detail, the exemplary embodiment of the novel controller shows a firing element 1 connected via a high-side switch and a low-side switch to an energy source which is formed, for example, by a battery 2 and a series circuit which is connected in parallel therewith and is composed of a diode 23 and a capacitor 3. The low-side switch is composed essentially of a MOS field effect transistor 4 of the n-channel type whose source terminal is connected to the negative terminal of the battery 2 and to the negative terminal of a voltage source 5. The drain terminal of the field effect transistor 4 is connected to a terminal of the firing element 1, whose other terminal is connected to the source terminal of a MOS field effect transistor 6 of the n-channel type.

The field effect transistor 6 forms an integral component of the high-side switch and is coupled via its drain terminal to the positive terminal of the battery 2 with intermediate connection of the diode 23. The gate terminal of the field-effect transistor 6 can be connected via a controlled switch 7 to the gate terminal of a MOS field effect transistor 8 of the n-channel type. The source terminals of the two field effect transistors 6 and 8 are coupled to one another and, with the intermediate connection of a resistor 9, to the inverting input of a differential amplifier 10. The non-inverting input of the differential amplifier 10 is connected, with intermediate connection of a resistor 11, to the drain terminal of the field effect transistor 8, the drain terminal of the field effect transistor 8 being additionally coupled via a power source 12 to the positive terminal of the voltage source 5. The output of the differential amplifier 10 is coupled via a resistor 13 to the non-inverting input of a further differential amplifier 14 whose inverting input is connected via a reference voltage source 15 to the negative terminal of the voltage source 5 and of the battery 2.

The output of the differential amplifier 14 is connected here to the gate terminal of the field effect transistor 8 in such a way that the output of the differential amplifier 14 is permanently connected to the gate terminal of the field effect transistor 8 and can be connected via the switch 7 to the gate terminal of the field effect transistor 6. The output of the differential amplifier 14 can additionally be connected, on the one hand, to the non-inverting input of a differential amplifier 16 via a resistor 150 and, on the other hand, to the inverting input of the differential amplifier 16 by means of a controlled switch 17. The inverting input of the differential amplifier 16 is coupled here via a capacitor 18 to the negative terminal of the voltage source 5 and to the battery 2, as is the non-inverting input of the differential amplifier 16 via a power source 19. The output of the differential amplifier 16 ultimately controls the switch 7. The switch 17 and the gate terminal of the field effect transistor 4 are controlled by an evaluation circuit 20 as a function of a signal supplied by a crash sensor 21 in the event of an impact.

The method of operation of the illustrated controller is based on the fact that the flow of current through the field effect transistor 6 causes the same to heat up. The volume of silicon of the field effect transistor 6 serves here as a thermal capacitor of an energy integrator. A change in the temperature of the volume of silicon results in a proportional change in the resistance of the drain-source path of the field effect transistor 6. By appropriately actuating the gate terminal of the field effect transistor 6, the resistance on the drain-source path of the field effect transistor 6 is kept constant. The change in voltage, which is necessary to keep the resistance constant, is proportional to the temperature and can thus be used for the energy calculation. For this purpose, when switching on occurs the gate voltage is stored and adopted as the starting value. The change in the temperature is determined with respect thereto. If this change in temperature exceeds a specific value, controlled switching off of the field effect transistor 6 takes place. However, the field effect transistor 4 could also be switched off in the same way by means of special measures.

In the exemplary embodiment, the change in temperature, and thus the energy drain in the field effect transistor 6, are determined by means of a comparator transistor, namely the field effect transistor 8, both field effect transistors 6 and 8 being coupled to one another in a thermally very satisfactory way. When switching on occurs, the field effect transistors 6 and 8 are operated in parallel at the input and in the process the resistance on the drain-source path of the field effect transistor 8 is measured by the latter being fed by the power source 12 with a constant current and the voltage over the drain-source path of the field effect transistor 8 being measured with respect thereto by means of the differential amplifier 10. The differential amplifier 14 which is connected downstream is used, in conjunction with the reference voltage source 15, to convert the floating voltage of the drain-source path of the field effect transistor 8 into a voltage which is referred to the negative terminals of the two batteries 2 and 5. At the output of the differential amplifier 14 there is thus a voltage available which is applied to the gate terminal of the field effect transistor 8 in order to control the resistance on the drain-source path of said field effect transistor 8.

By connecting the field effect transistors 6 and 8 in parallel at the input end, the resistors R₆, R₈ of the drain-source paths behave inversely proportionately to the areas F₆, F₈ of the field effect transistors 6 and 8 (R₆·F₆=F₈·R₈). The actuation voltage for the gate terminal of the field effect transistor 8 is also evaluated for the energy calculation in that the voltage occurring at the gate terminal of the field effect transistor 8 before the switching on operation is stored in the capacitor 18 and the switch 17 is opened when the controller is switched through by the evaluation device 20.

In this way, the previous value remains stored in the capacitor 18. In this case, the gate terminals of the two field effect transistors 6 and 8 are also connected in parallel with one another so that temperatures changes at the field effect transistor 6 act on the actuation voltage for the two gate terminals. This change is fed via a resistor 150 to the differential amplifier 16, to which in addition a current from the current source 19 is fed. The current of the current source 19 marks a temperature limiting value here.

If the current flowing through the resistor 150 then rises, in conjunction with the reference current provided by the current source 19, above a level which is predefined by the voltage via the capacitor 18, the differential amplifier 16 switches over at its output and disconnects the gate terminal of the field effect transistor 6 from the gate terminal of the field effect transistor 8. As a result, the field effect transistor 6 is switched off again and the circuit which encloses the firing element 1 is blocked.

If the crash sensor 21 is triggered, the evaluation circuit is consequently actuated and then switches on the switch 17 and the field effect transistor 4 in a clocked fashion. This means that during the switch-on phase repeated switching on and off takes place, while in the switched-off state the field effect transistors 4 and 6 are permanently switched off. The energy is thus fed to the field effect transistors 4 and 6 in portions, making it possible also to supply a plurality of firing circuits (not illustrated in the drawing) from one energy accumulator, specifically from the battery 2 in conjunction with the capacitor 3. The energy pulses are preferably dimensioned in such a way that a single pulse cannot give rise to firing.

After a sufficient quantity of energy has flown through the firing element 1, the firing element 1 fires, as a result of which an airbag 22 is inflated. After firing, the firing element 1 either has a very high resistance so that the flow of current through the field effect transistors 4 and 6 is in any case extremely small, or else a very small, short-circuit-like resistance, which results in heating, in particular of the field effect transistor 6. As a result of the increase in temperature, the firing element is then switched off in the manner described above by means of the field effect transistor 6. Consequently, no further energy is removed from the energy source composed of the battery 2 and/or capacitor 3, which energy is then available for further firing elements.

The electrical energy E which is taken up by the field effect transistor 6 as a function of the drain-source current I of the field effect transistor 6, of the drain-source resistor R₆ of the field effect transistor 6 and of the time t can be described formally as follows:

E=I²·R₆·t≈Q=C·m·ΔT

on condition that the time t is so short that the conduction away of heat can be ignored.

The electrical energy E which is taken up is furthermore proportional to the quantity of heat Q which is itself equal to the product of the specific thermal capacity C of the field effect transistor 6, the mass m of the semiconductor and the change in temperature ΔT. The resistance R₆ is proportional here to the product of the gate voltage U_{gs} of the field effect transistor 6 of the temperature T and a constant K which is dependent on the semiconductor area.

R₆=K·T/U_{gs}.

This means that, in order to keep the resistance R₆ constant when the temperature T rises owing to an energy drain, the gate voltage must be correspondingly adjusted. The change in voltage which is thus necessary can, however, be evaluated in order to determine the change in temperature and thus to determine the energy taken up.

Therefore, for correct firing a particular quantity of energy must be fed within a specific time period as a function of the firing cap used. If the same energy is fed, for example, over a relatively long time period, there is, on the other hand, no firing because the necessary heat is conducted away again and the temperature which is necessary for firing (approximately 300 degrees Celsius at the firing wire) is not reached.

We claim:

1. A control device for a vehicle occupant protection device with a firing cap for activating the vehicle occupant protection device, comprising:
an energy source for providing a supply voltage for the firing cap;
a switching transistor for connecting the firing cap to said energy source, said switching transistor having a control terminal and a controlled path connected in series with said energy source and the firing cap; and
a control circuit connected to said control terminal of said switching transistor and configured to control said switching transistor to:
maintain a resistance of said controlled path constant in a switched-on state of said transistor, evaluate a signal present at said control terminal at that time, determine an energy being converted in said switching transistor from the signal at said control terminal and, when a predefined energy limiting value is reached within a specific time, switch off said switching transistor.

2. The controller according to claim 1, which comprises a capacitor connected in parallel with said energy source.

3. The controller according to claim 1, wherein said control circuit is connected to a sensor and said control circuit switches through said switching transistor upon receiving specific signals from said sensor.

4. The controller according to claim 3, wherein said control circuit is configured to switch through said switching transistor in clocked fashion.

5. The controller according to claim 1, wherein said control circuit includes a comparator transistor having a controlled path supplied by a power source, and wherein, for determining the resistance on said controlled path of said switching transistor, a resistance on said controlled path of said comparator transistor is determined by determining a voltage across said controlled path of said comparator transistor.

6. The controller according to claim 1, wherein said control circuit includes a comparator transistor having a controlled path, and wherein:
a resistance on said controlled path of said comparator transistor is determined when said switching transistor is switched off;
a respective current resistance value is stored when said switching transistor is switched on;
said control terminal of said switching transistor is coupled to a control terminal of said comparator transistor when said switching transistor is switched on; and
a voltage value at said coupled control terminals of said switching transistor and said comparator transistor is subsequently regulated with respect to a stored voltage value of said comparator transistor when said switching transistor is switched on.
